(19) United States
(12) Patent Application Publication
(10) Pub. No.: US 2011/0219071 A1
(43) Pub. Date: Sep. 8, 2011

(54) METHOD AND SYSTEM FOR CONDUCTING PUBLIC FORUMS

(75) Inventors: Robert A. Vogel, Trinidad, CA (US); Michael D. Alvarez-Cohen, Berkeley, CA (US)

(73) Assignee: Peak Democracy, Inc., Trinidad, CA (US)

(21) Appl. No.: 13/040,248

(22) Filed: Mar. 3, 2011

Related U.S. Application Data
(60) Provisional application No. 61/311,694, filed on Mar. 8, 2010.

(51) Int. Cl. G06F 15/16

(52) U.S. Cl. 709/204

(57) ABSTRACT

A method for conducting a public forum of a government agency includes, in a public forum processor, receiving a statement from a submitter, the statement related to the public forum of the government agency and processing the submitted statement including assigning the submitted statement to a list of pending statements, evaluating the submitted statement according to civility criteria of the public forum of the government agency, and on the basis of said civility evaluation, assigning the submitted statement to a list of approved statements. The method also includes sending a pending statement in response to a request for the list of pending statements, including the content of the pending statement and information related to said civility evaluation of the pending statement.

### RELATED APPLICATIONS

This application claims the benefit of U.S. Provisional Patent Application No. 61/311,694 filed Mar. 8, 2010 under 35 U.S.C. §119(e) which application is hereby incorporated herein by reference in its entirety.

### FIELD OF THE INVENTION

The systems and methods generally relate to online forums and, in particular; to conducting online public forums of a government agency.

### BACKGROUND

Freedom of speech, or the freedom of expression, is recognized in international and regional, human rights law. The notion of freedom of expression is intimately linked to political debate and the concept of democracy. Legal systems recognize that limits on the freedom of speech are necessary when freedom of speech conflicts with other values or rights. Limitations on freedom of speech may follow the “harm principle” or the “offense principle” for example in the case of pornography or “hate speech”. Most jurisdictions allow legal actions, civil and/or criminal, to deter various kinds of defamation and to protect against groundless public criticism and to protect people's emotional well-being and right to privacy.

As is known in the art, government agencies hold public meetings to obtain public testimony or comment. In matters of public concern, it is important for government agencies to be informed and prepared in advance of any public hearing. Hearings often occur late in the process and may leave citizens with the impression that government officials have already made up their minds and do not want to hear further comment. Public hearings that occur in public chambers and board rooms are often formal and can be intimidating to citizens who are not accustomed to public speaking. The format of public meetings often pushes time for public comment to the end of the meetings, which can leave little, if any, room for reasonable discussion and results in many unheard voices and ideas.

For a variety of reasons, many citizens have difficulty participating in public meetings and other forms of civic engagement because they are intimidated by speaking in front of others, uncomfortable confronting others with opposing viewpoints, uneasy about publicly stating personal opinions, and/or too busy to attend evening meetings. As a result, many community voices remain unheard and much of the civic discourse tends to be driven and dominated by only a few viewpoints. Civic leaders, therefore, are often quite unaware, of what many citizens think about important issues facing the community.

### SUMMARY

In contrast to individuals and corporations, government agencies are subject to legal requirements including free speech laws that protect a person's right of expression. It is important to balance free speech rights against other important rights and sensibilities, such as a person's right to physical and emotional well-being, right to privacy, and community standards of appropriateness. The systems and method described herein enable government agencies as well as other organizations to provide public comment forums that protect free speech rights and with the order and decorum of civil public discourse. Government agencies include, but are not limited to local, county, state and national governments (e.g., all levels of governments of countries around the world) as well as public school boards, utility commissions, transportation agencies, park services, and public works projects.

The systems and methods maintain the order and decorum using user authentication to prevent fraud and deception, comment monitoring to promote civility and reduce and/or eliminate rude and inappropriate comments, and provide analytical capabilities that help government agencies better understand, guide, and respond to the public comment process. Certain features described herein help protect free speech rights of citizens while also providing a civil manner to the public comment process. This can result in far greater overall public participation and can result in many more opinions being submitted, especially by citizens who tend to feel intimidated by the sometimes highly polarized atmosphere of a public hearing, are fearful of public speaking, and/or fear others' reactions to their opinion. Further, many citizens are unable, unwilling, or it may be too inconvenient for them to attend public hearings, which are frequently held during the evening.

In one aspect, a method for conducting a public forum of a government agency includes, in a public forum processor, receiving a statement from a submitter, the statement related to the public forum of the government agency, processing the submitted statement including assigning the submitted statement to a list of pending statements, evaluating the submitted statement according to civility criteria of the public forum of the government agency, and, on the basis of said civility evaluation, assigning the submitted statement to a list of approved statements. The method includes sending a pending statement in response to a request for the list of pending statements, including the content of the pending statement and information related to said civility evaluation of the pending statement.

In further embodiments, the method includes one, or more of the following features: the public forum corresponds to an agenda item associated with a public hearing of the government agency; the public forum corresponds to a topic of interest related to the government agency; the civility criteria include identifying at an undesirable word or phrase; the civility criteria include order and decorum criteria of the public forum of the government agency; the order and decorum criteria of the public forum of the government agency include disruptiveness criteria of the public forum of the government agency; the civility evaluation of the submitted statement includes sending a response to the statement submitter, the response including information related to the civility evaluation of the submitted statement and an invitation to modify the submitted statement; receiving a modified statement from the submitter and performing a successive civility evaluation of the modified statement; assigning the submitted statement to a list of approved statements further includes assigning the submitted statement to the list of approved statements based on a registration status of the submitter; assigning the submitted statement to the list of approved statements based on the registration status of the submitter includes authenticating a submitter identifier associated with the submitter of the statement; the submitter identifier includes a submitter name and a submitter electronic mail address; the submitter identifier further includes a submitter residential address; sending the pending statement in response to a request for the list of pending statements includes sending the pending statement to a reader, at least one of the reader and the submitter being a citizen of a seat of government associated with the government agency; sending at an approved statement in response to a request for the list of approved statements, including the content of the approved statement; sending the approved statement in response to a request for the list of approved statements further includes sending the approved statement to a reader, at least one of the reader or the submitter being a citizen of a seat of government associated with the government agency; further including receiving information from the submitter including a submitter identifier, wherein said sending the pending statement in response to a request for the list of pending statements further includes sending information related to the submitter identifier; the received submitter information further includes an anonymity indicator indicative of the submitter's desire to remain anonymous; the anonymity identifier is configurable; a public forum administrator enables or disables the anonymity identifier; further including receiving information including a submitter residential address and sending a submitted statement based on the submitter residential address; further including receiving a request from a user to subscribe to the public forum of the government agency and subscribing the user to the public forum of the government agency based on user credentials; further including monitoring users of the public forum of the government agency, the users of the public forum including users submitting statements to the public forum and users requesting statements from the public forum and comparing the users submitting statements to the users requesting statements; said comparing includes evaluating a relationship of a number of users submitting statements to the public forum to a number of users requesting statements from the public forum, the relationship indicative of user participation in the public forum of the government agency; further including determining a public forum efficacy factor based on received submitter statements and a predetermined statement completion time; the public forum efficacy factor is determined according to a number of received submitter statements*the predetermined statement completion time, wherein the predetermined statement completion time corresponds to a predetermined time required to complete a statement of the public forum of the government agency; further including conducting the public forum of the government agency in a first session by embedding access to the public forum in, a first web page, and conducting the public forum of the government agency in a second session by embedding access to the public forum in a second web page.

In another aspect, a system for conducting a public forum of a government agency includes a statement broker configured to receive a statement from a submitter, the statement related to the public forum of the government agency, and to assign the submitted statement to a list of pending statements, a public forum processor configured to assign the submitted statement to a list of approved statements based on a civility evaluation of the statement according to civility criteria of the public forum of the government agency, wherein the statement broker is further configured to send a pending statement in response to a request for the list of pending statements, including content of the pending statement and information related to the civility evaluation of the pending statement.

In a further aspect, a computer-readable medium having encoded thereon software for conducting a public forum of a government agency includes instructions for evaluating a statement received from a submitter and related to the public forum of the government agency. Evaluating the statement includes assigning the submitted statement to a list of pending statements and moving the submitted statement to a list of approved statements based on an evaluation of the submitted statement according to civility criteria of the public forum of the government agency. The instructions further provide a pending statement in response to a request for the list of pending statements, including the content of the pending statement and information related to the civility evaluation of the pending statement.

### BRIEF DESCRIPTION OF THE DRAWINGS

The foregoing features of this systems and methods described herein may be more fully understood from the following description of the drawings in which:

FIG. 1 is a block diagram of an embodiment of a system for conducting a public forum of government agency;

FIG. 2 is a block diagram of a further embodiment of the system of FIG. 1;

FIG. 3 is a diagram of an embodiment of a message related to a public forum statement;

FIG. 4 is a flow diagram of an embodiment of a method for conducting a public forum of a government agency;

FIGS. 4A, 4B, and 4C are flow diagrams of an embodiment of a public forum processor interacting with public forum users;

FIGS. 5A, 5B, 5C, 5D, 5E, 5F, 5G, and 5H are embodiments of graphical user interfaces of the type which may be provided by the systems and method described herein;

FIG. 6 is a block diagram showing an exemplary hardware and operating environment of a suitable computer for use with embodiments of the invention, and;

FIG. 7 is a block diagram showing an exemplary client-server environment of a suitable for use with embodiments of the invention.

### DETAILED DESCRIPTION

Before departing on a detail description of embodiments of the systems and methods described herein, it may be helpful to review how government agencies conduct public meetings. In general, government agencies conduct public meetings under strict rules of order and decorum, designed to ensure that everyone has an equal opportunity to participate in the public meeting. These rules enable government agencies to:
restrain speakers from disruptive speech,
remove extremely disruptive speakers from meetings,
limit each speaker's time to prevent any one person from dominating meetings,
provide personal attention to anyone needing special assistance, and
protect speakers' privacy by allowing them to speak without sharing their home address.

In general overview, the systems and methods described herein are directed toward a monitored public forum that enables participants and government officials to share and review statements related to topics of interest and/or agenda items of public concern. The public forum is configured to have the order and decorum of a government meeting (or hearing) while providing citizens free speech rights crucial to a well-functioning, modern democracy (and promulgated by state and federal constitutions).

In some embodiments, the systems and methods described herein enable citizens to post statements in an on-line public comment process hosted by a city or other government agency. The public comment process includes the statements of citizens related to various public interest topics and issues under consideration by a governing council, commission or board. A neutral third party reviews the statements for their adherence to standards of appropriateness and to prevent fraudulent postings.

In some embodiment, to prevent any one person from dominating a public forum, each participant is limited to one statement per topic. To enforce that limit, and to identify which statements come from inside, the community, public forum monitors collect and authenticate each participant's real name, home address and email address.

In the same or different embodiment, monitors evaluate submitted statements for disruptive content and, if found, move the statement to a list of disruptive statements. The monitors may contact the disruptive statement's author to suggest that the author modify and resubmit the statement. It should be noted that monitors do not edit and/or delete disruptive statements because doing so may violate the author's free speech rights. Rather, disruptive statements are assigned a pending status to segregate them from approved statements. Public forum users may elect to view, these pending statements or to filter these statements to view only approved statements.

Some residents will be concerned that publicly expressing their opinions may harm their relationships with others in the community. Accordingly, in some embodiments, public forum users may participate anonymously to prevent other public forum users from knowing their identity. It should be noted that in these embodiments, public forum users will need to divulge some personal information during a registration process to help prevent and/or eliminate fraudulent statement postings. However, such personal information does not need to be divulged to public forum participants. This can help keep personal information confidential while assuring the public that the various public forum participants are real and distinct members of the community.

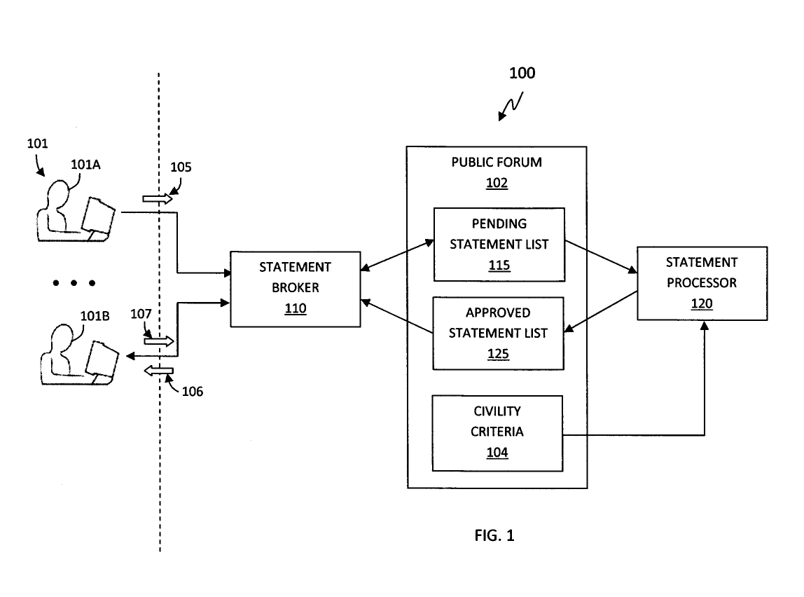

Referring now to FIG. 1, a system 100 for conducting a public forum 102 of a government agency includes a statement broker 110 configured to receive a statement 105 from a public forum user 101A (generally designated by reference numeral 101) and assign the statement 105 to a list of pending statements 115 of the public forum 102. The system 100 also includes a statement processor 120 configured to evaluate the statement 105 using civility criteria 104 of the public forum 102 and assign the statement 105 to a list of approved statements 125 on the basis of the civility evaluation of the statement 105.

The statement broker 110 is also configured to receive a request 107 from a public forum user 101B for one or more pending statements from the list of pending statements 115 and to send a response 106 to the public forum user 101B including pending statement information.

In a further embodiment, request 107 includes a request for one or more approved statements from the list of approved statements 115 and response 106 includes approved statement information.

### Public Forums

In a further embodiment, the public forum 102 of the government agency corresponds to an agenda item associated with a public hearing of the government agency. A public hearing, such as one conducted by a city government, occurs at time that is before, after, and/or contemporaneous with the public forum 102. The public hearing includes participants such as citizens, public officials (such as Selectman, board members of government agencies, etc.), private officials (such as business representatives from companies with an interest or stake in the agenda item), and/or various support participants (such as note-takers, subject matter experts, town engineers, news agencies, etc.). An exemplary agenda item of the public hearing includes issues and questions related to improvements to a street or street intersection in the city, such as adding street lights, public walkways, signs, etc.

In a further embodiment, the public forum 102 corresponds to a topic of interest related to the government agency. An exemplary topic of interest includes golf course and/or tennis court facilities to be erected in a city.

In general, the public forum 102 can be said to complement, augment, and diversify a public hearing process. The public forum 102 can enable government officials to obtain feedback on important community issues in advance of a public hearing. This can help reduce any surprises, and can help government officials prepare for a public hearing, as well as improve public hearing deliberation and increase public trust.

It should be noted that in some instances the public forum 102 can replace the public hearing process. This may be the case if the public hearing is cancelled, due to inclement weather and/or other hindrances, such as an inability to reserve a meeting place or if an allotted meeting place is unavailable. In some instances, a public hearing is not necessary and a public forum 102 may be desired to obtain public input and/or feedback.

### Public Forum Statements

The statement processor 120 assigns one or more status conditions to a submitted statement 105. When the statement processor 120 receives a statement 105 from a submitter, it assigns a pending status the statement 105 and, in some embodiments, copies the statement 105 to a list of pending statements 115 which is a convenient way to organize, store, and/or offer the statements for consumption. The statement processor 120 verifies the submitter's identity by requiring the submitter to register and properly verify credentials. Registration may also reduce and/or eliminate other fraudulent actions, such as attempts to submit multiple statements in order to influence the civil discourse, for example, toward one outcome or another.

The statement processor 120 evaluates the statement 105 according to standards of appropriateness, which in some embodiments includes civility criteria 104 as will be further discussed hereinafter below. Once the statement processor 120 validates submitter credentials and the statement 105 is deemed to be appropriate, the statement processor 120 assigns an approved status to the statement 105 and, in some embodiments, copies the statement 105 to a list of approved statement 125.

It should be noted that free speech rights are protected throughout the statement monitoring process because submitted statements 105 are not edited (although they may be modified by the statement submitter) and can always be reviewed and read by other members of the public forum. However, members of the public forum may choose whether or not to view statements 105 that are deemed to violate civility standards. In this way, the statement monitoring process maintains freedom of speech while controlling civility standards. The level of civility control can be “black and white” in that members may choose to either view or not view inappropriate content, or they may control the level of civility rather finely by drawing a line between their own view of what's appropriate and what's not appropriate. For example, members of the public (or the government agency) may choose to view all but the most offensive comments. In most instances, this may effectively result in no filtering of comments, since such comments are rare unless the debate is considerably heated and polarized.

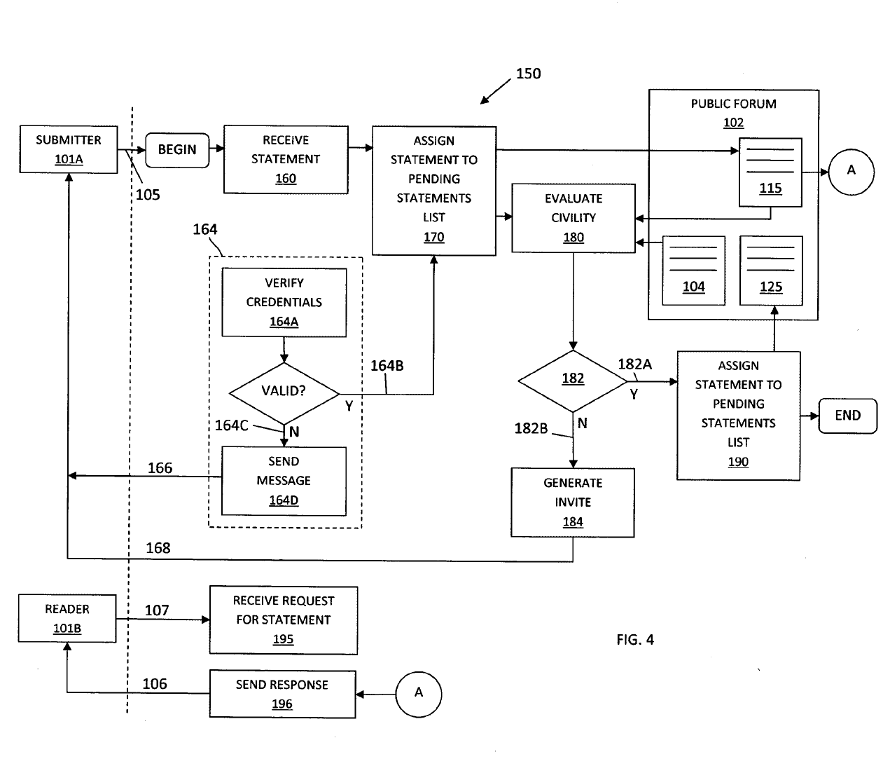

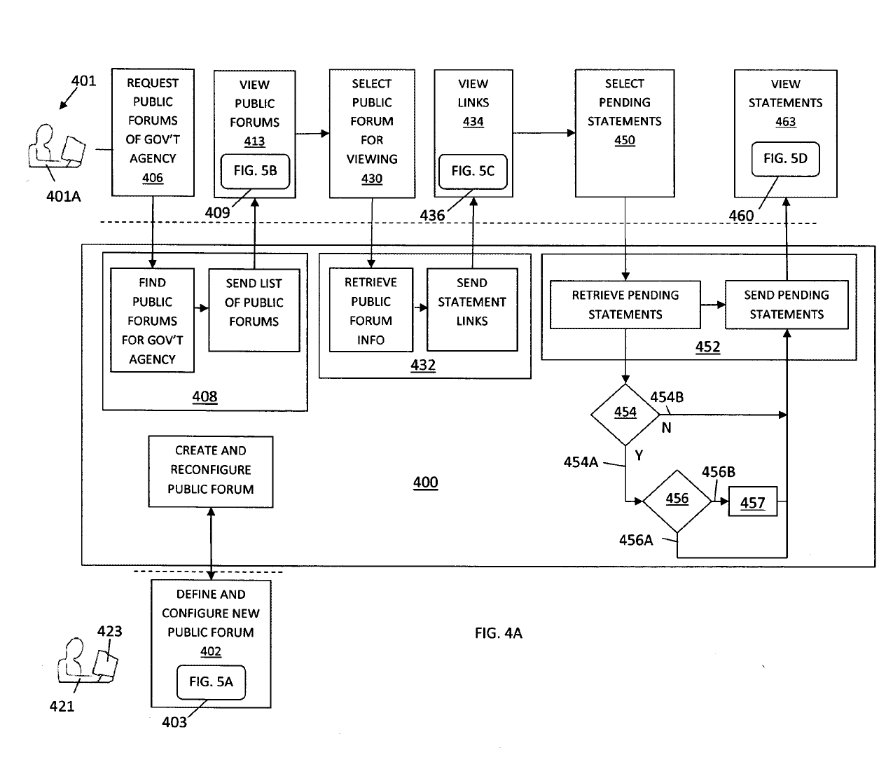

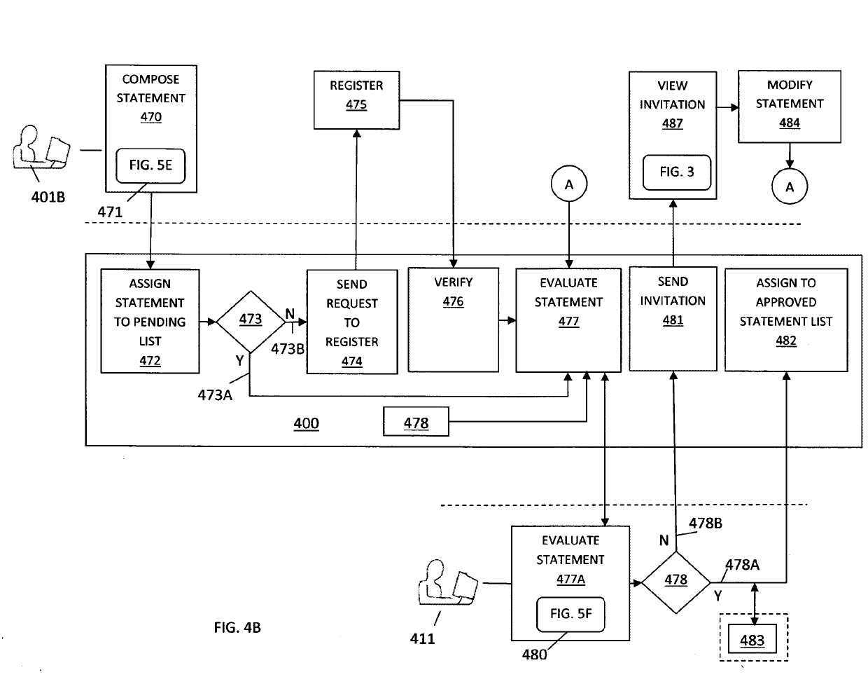

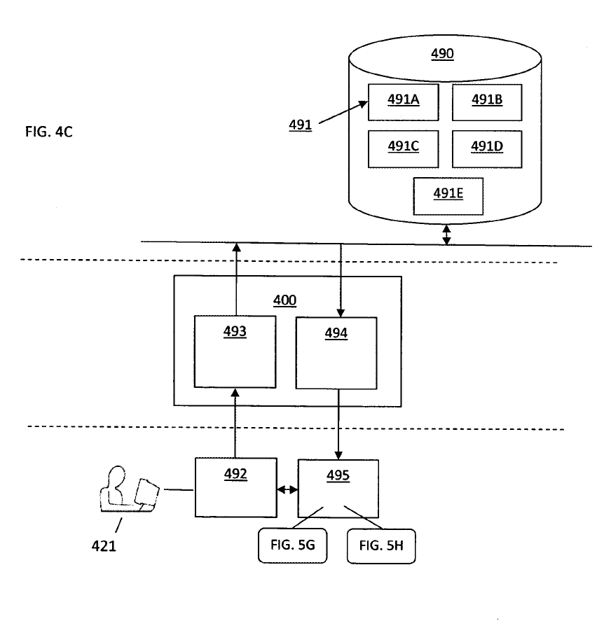

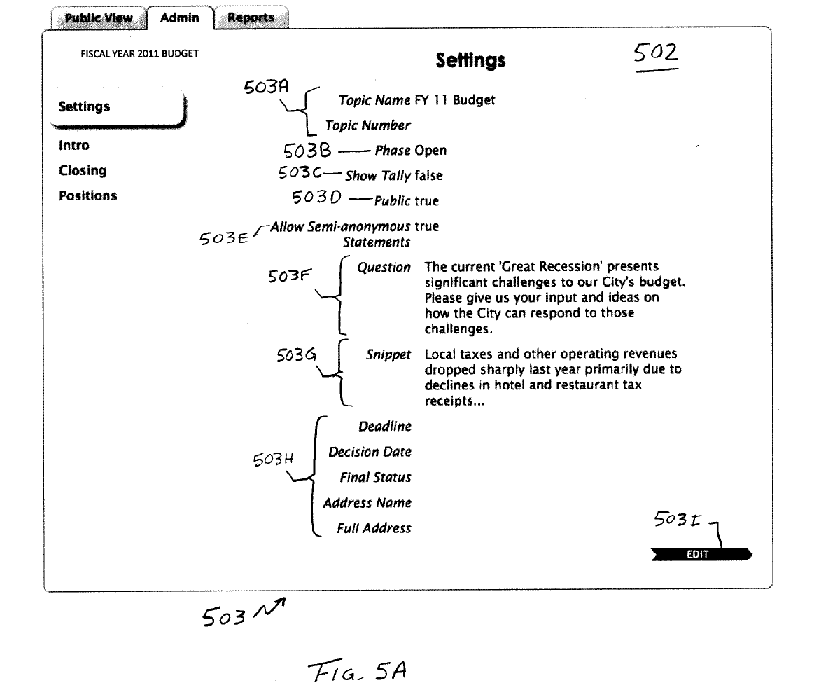

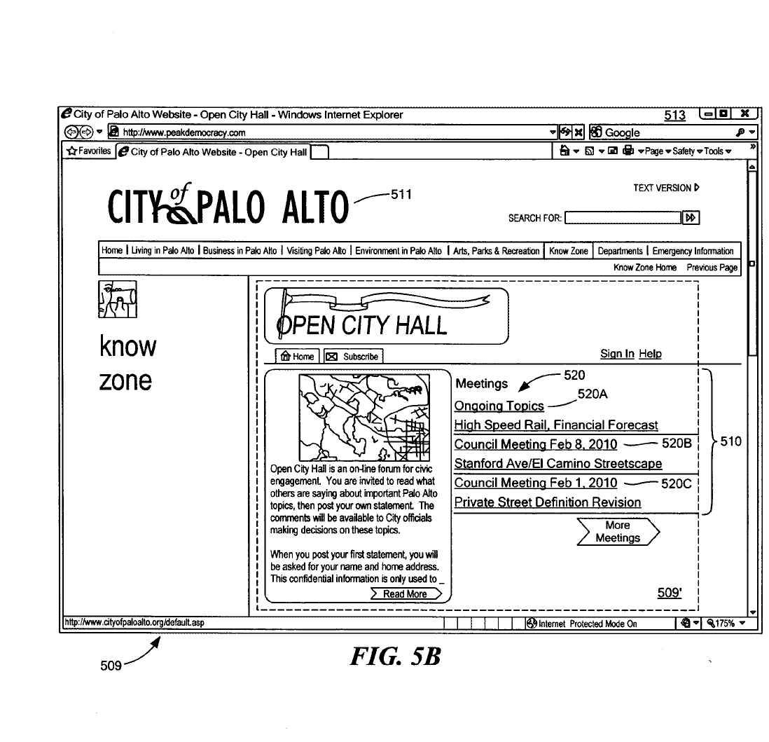

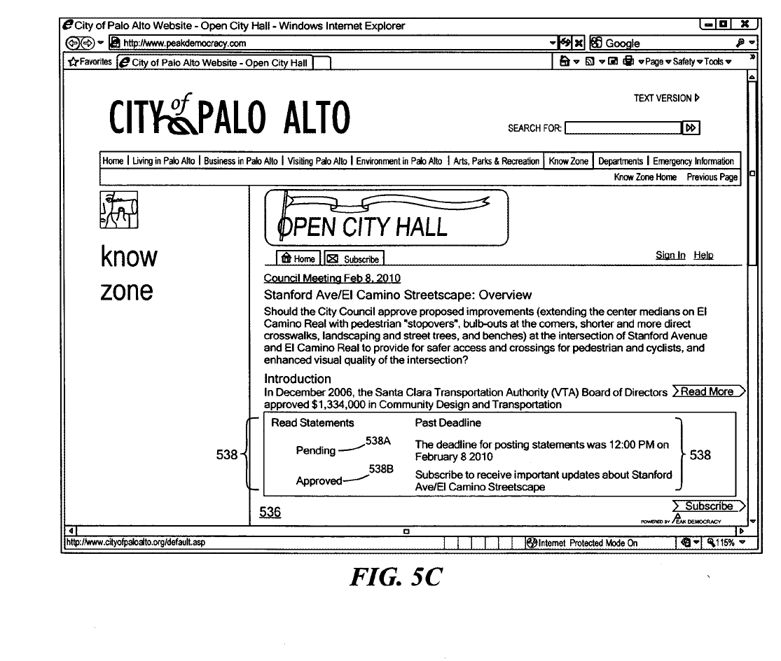

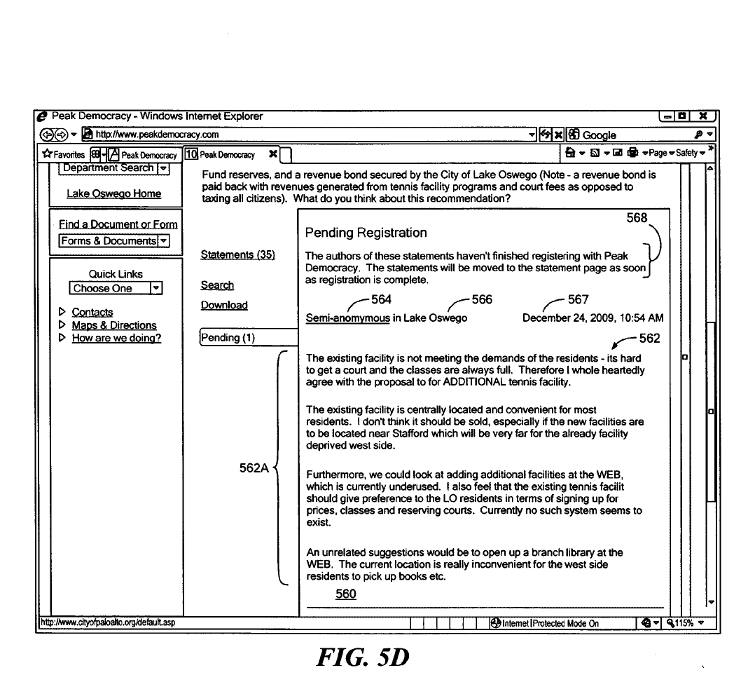

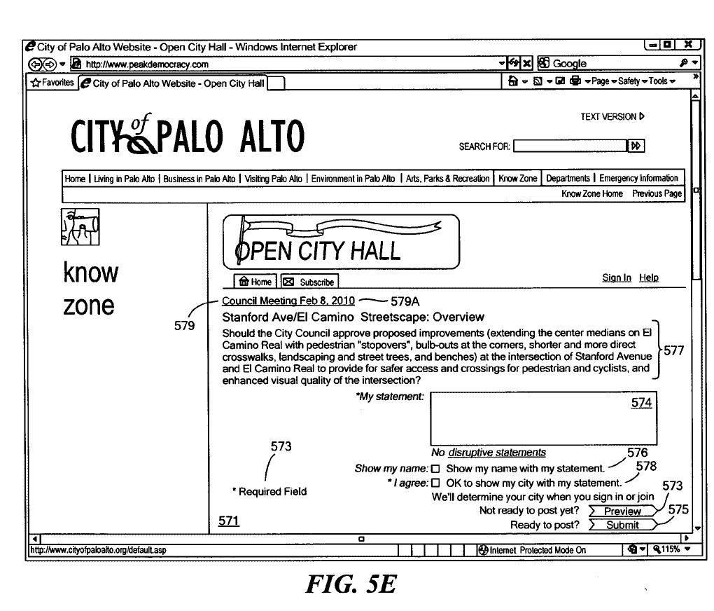

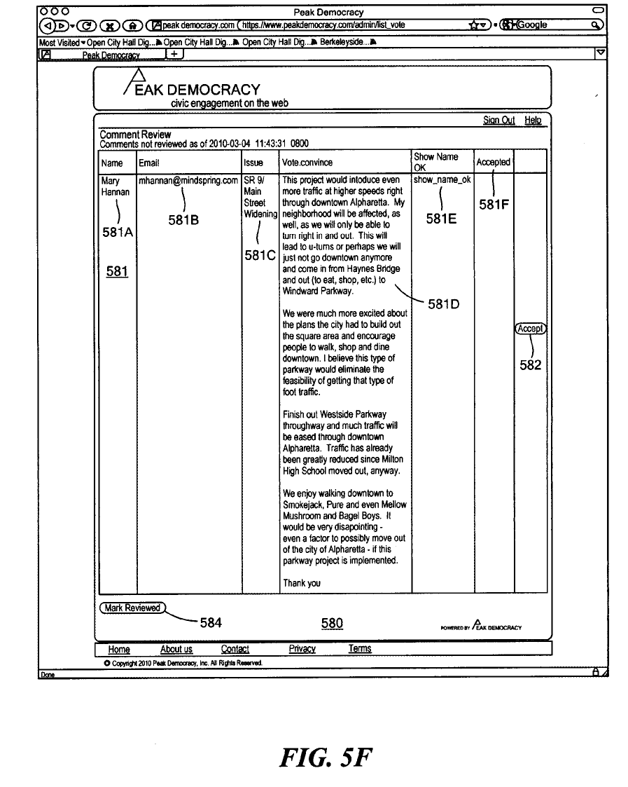

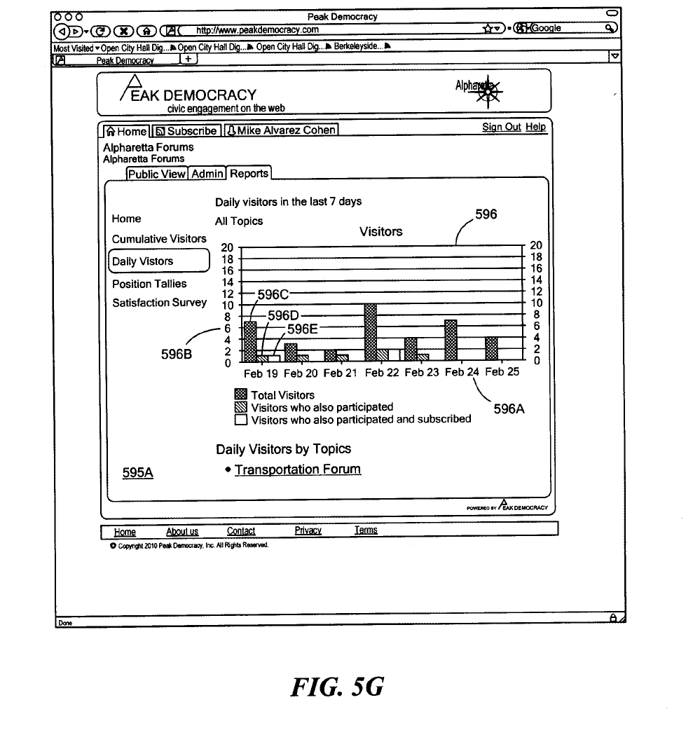

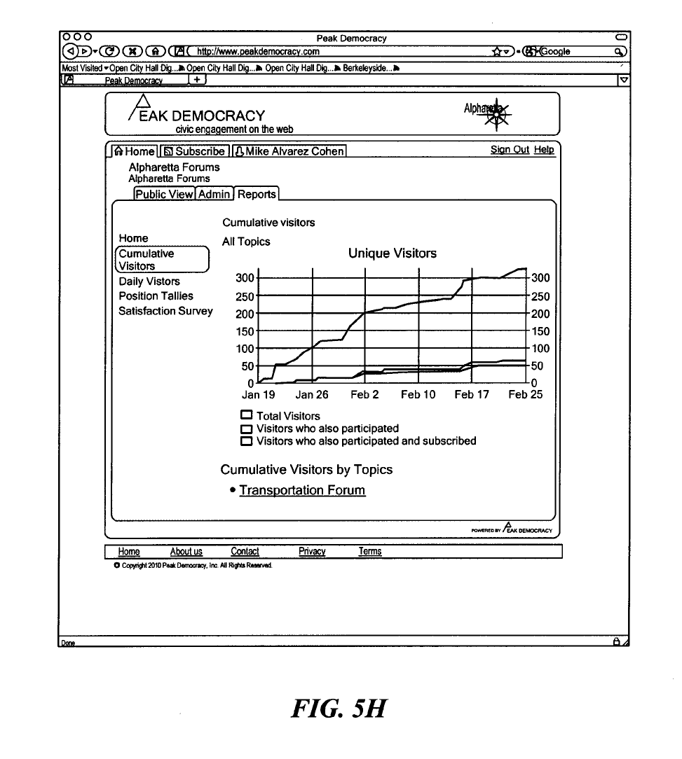

Referring again to FIG. 1, the public forum 102 includes statements 105 submitted by public forum participants 101. In one non-limiting example, a submitter 101A submits a statement 105 using a client environment to be described further in conjunction with FIGS. 4B and 5E. In some embodiments, the statement is a text string that includes content (i.e., a submitter's thoughts and expressions in a written language) related to the public forum 102. The content can include, but is not limited to an opinion of the submitter 101A, a statement of fact, a question, a predefined statement and/or voting option selected by the submitter 101A and offered by the public forum. The content can include formatting information such as text styles and attributes, paragraph styles and attributes, page style and attributes, etc.

In an exemplary public forum 102 related to tennis court facilities, a statement 105 can include the following:
“I agree that more courts are need in LO. Thank you to all who are working hard at trying to provide a larger and more user-friendly tennis facility to our community. It is evident, by the number of people that come and go at the present LOITC, that tennis is enjoyed by MANY people of ALL age groups in our community. For the benefit of everyone in LO, let's continue to support the efforts of people who are spending countless hours on this project.”

It should be noted that statements 105 are not limited to text strings and can include videos, photographs, presentations, audio information, and/or combinations thereof.

### Civility Evaluation

The statement processor 120 evaluates whether a submitted statement 105 meets the civility criteria 104 of the public forum 102 of the government agency. The civility evaluation may include a result indicative of whether or not the submitted statement 105 meets the civility criteria 104. The result may be binary in nature including one of the following options:
(1) the statement meets civility criteria, or
(2) the statement does not meet civility criteria

In some embodiments, the result includes a range of values indicative of a degree to which the statement does or does not meet the civility criteria. For example, the range of civility values may be on a scale of 1 to 10, where a value of 1 indicates that a statement is minimally offensive and a value of 10 indicates that a statement is maximally offensive.

On the basis of the civility evaluation, the statement processor 120 assigns the submitted statement to the list of approved statements 125. For example, if the statement 105 meets civility criteria, then the statement processor 120 assigns the statement to the list of approved statements 125. In the alternative, if the statement 105 does not meet civility criteria, then the statement processor 120 does not assign the statement 105 to the list of approved statements 125. Rather, the statement 105 remains on the list of pending statements 115.

In other embodiments, the statement processor 120 may assign the statement 105 to the list of approved statements 125 on the basis of the above-mentioned range of values. For example, the statement processor 120 may assign a statement 105 with a civility value less than 5 to list of approved statements 125, whereas a statement 105 with a civility value greater than or equal to 5 may remain on the list of pending statements 115.

In some embodiments, the statement processor 120 performs one or more of the following:
(1) assigns the statement 105 to a list of pending statements 115 and provides pending statements to a public forum user 101B
(2) describes why a statement 105 does not meet civility criteria 104 and provides the description to an author 101A of the statement 105, and/or
(3) invites the author 101A to modify the statement 105.

In a further embodiment, the statement processor 120 is incapable of editing and/or deleting a submitted statement 105, regardless of whether or not the submitted statement 105 violates civility criteria 104 of the public forum 102. Rather, if a submitted statement 105 violates civility criteria 104, the statement 105 remains on the list of pending statements 125. While on the list of pending statements 125, a public forum user 101 can elect, whether or not to view the statement 105.

In a further embodiment, public forum users 101 and/or public forum administrators (who define and configure a public forum 102 on behalf of a government agency) control whether or not to view pending statements 125. For example, a public forum user 101 may elect not to view pending statements 125 for fear that he/she will be offended by the statement content. In the same or different embodiment, public forum administrators may configure the public forum 102 to prevent pending statements 125 from being viewed by public forum users 101. In the same or different embodiment, a public forum user 101 may receive a warning before receiving pending statements 125. Further, viewing pending statements 125 may be restricted to authorized public forum users 101 as defined by public forum administrators.

Advantageously, such features of the systems and methods described herein ensure that public forums are conducted in terms of free public discourse, while in a civil manner.

### Civility Criteria

Referring again to FIG. 1, in some embodiments, civility criteria 104 of the public forum 102 include identifying one or more undesirable words or phrase within a submitted statement 105. An undesirable word may include a profanity (i.e., a swear word, sexually deviant word, etc.), a derogatory word related to one's identity or status (i.e., one's race, religion, creed, occupation, habits), etc. Undesirable phrases include words and expressions which, as a whole or at least partially, are offensive. Undesirable phrases may be included in one or more sentences. Exemplary undesirable phrases include “John Smith is aback-stabbing jerk!”, or “I wish you and your evil politician friends like Bill Clinton an early death.”, or “Your friend is a flamer and he can go to hell!”

It should be noted that the above-described undesirable words and phrases should not be construed as limited to the provided examples.

The civility criteria 104 of the public forum 102 may optionally include identifying false and/or fraudulent statements. An example of a fraudulent statement includes a statement from a submitter who assumes a false identity (i.e. the submitter is not who he/she claims to be). The false identity may include that of another person (e.g., a well-known public figure such as Bill Clinton) and/or public forum user 101 (e.g., the submitter's neighbor). A fraudulent statement may also include a statement about another public forum user 101 or, person that the submitter knows to be false. Laws may help define and discern false and/or fraudulent statements, including defamation (i.e., statements related to one's reputation, such as libel), false light, appropriation, false contracts, etc.

In some embodiments, the civility criteria 104 of the public forum 102 include order and decorum criteria related to free and civil discourse. Such order and decorum criteria may be substantive and/or procedural in nature. For example, substantive order and decorum criteria may include one or more rules for addressing other public forum users 101 and/or certain officials having a formal title, such as a judge magistrate of the court.

Substantive order and decorum criteria may further include a manner of submitting statements 105 directed to other public forum users 101 or the public forum 102 as a whole, prepared statements, such as a prepared text, statements 105 including citations, etc.

Procedural order and decorum criteria include, for example, order of statement submission meant to control public forum engagements. For example, public forum users 101 may include a first group of users representing all those in favor of public works project XYZ and a second group of users representing all those not in favor of the public works project XYZ. Order of statement submission criteria in this example may include the following:
(1) first group submits a statement (as a result of a coin-toss)
(2) second group submits a statement
(3) first group responds to second group statement
(4) second group responds to first group statements, etc.

Order and decorum criteria may further include statements 105 and/or requests to submit a statement 105 that ordinarily would not abide by the order of statement submission criteria.

Order and decorum criteria may include other rules of public forum discourse, such as limiting each public forum user 101 to a single statement on a particular agenda item and/or topic. In the same or different embodiment, a public forum user 101A may be allowed to submit a first statement and a second statement in response to statement regarding the first statement.

In some embodiments, civility criteria include Robert's Rules of Order.

The civility criteria 104 of the public forum 102 may optionally include disruptiveness criteria such as personal attacks, profanity, commercial advertising or content which is entirely off-topic (i.e. irrelevant to the public forum 102), and statements from a public forum user 101A who has falsified his/her registration information with the intent to post multiple statements in a public forum 102 or to misrepresent his/her city of residence.

Personal attacks can include disparaging remarks which impute motives to a person's action. However, a statement of fact, or of one's own opinion are generally not personal attacks and therefore do not violate disruptiveness criteria, even though others may strongly disagree and be offended by such statements. Some non-limiting examples of statements which are personal attacks are shown in Table 1 below, alongside other statements which are not personal attacks.

TABLE 1

| Personal Attack | Not A Personal Attack |
|---|---|
| He lied. | He said he did X, but in fact he did Y. |
| She misrepresented the truth. | I don't trust her. |
| He is greedy. | He is making plenty of money. |
| It is merely a power play on her | She will announce her candidacy soon. |
| part. | |

### Monitors, Invitations to Modify Statements, Editing Statements

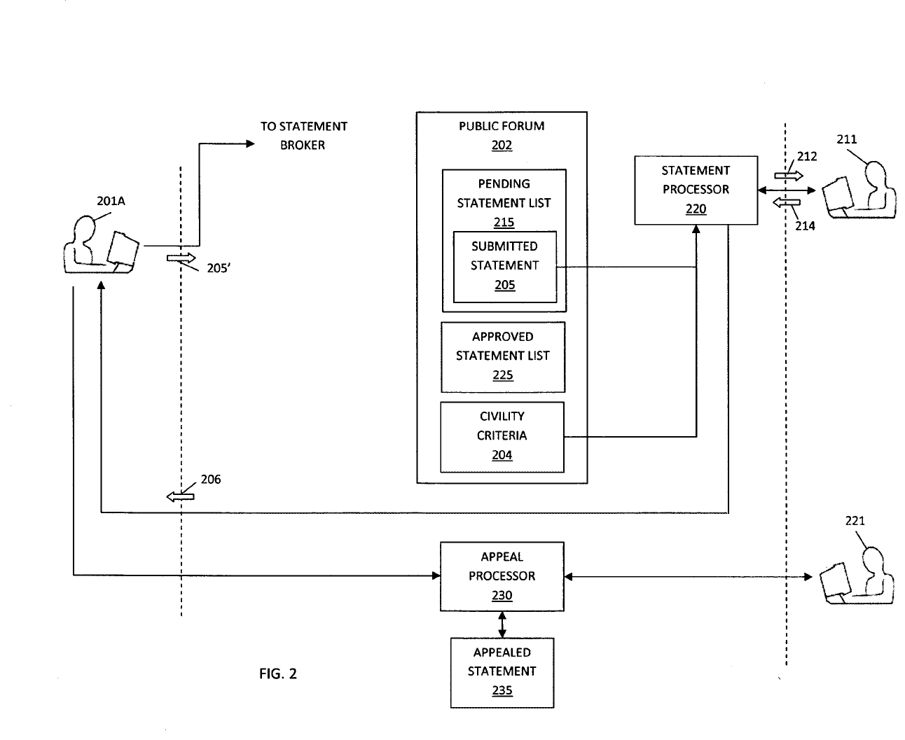

Referring now to FIG. 2, in a further embodiment, a statement processor 220 evaluates a submitted statement 205 and, if the submitted statement 205 does not meet civility criteria 204 of a public forum 202 of a government agency, the statement processor 220 sends a response 206 to a statement submitter 201A including a request to modify the submitted statement 205. In response to the request to modify the submitted statement 205, the submitter 201A may submit a modified statement 205′.

In some embodiments, the statement processor 220 includes one or more automated processors for processing submitted statements 205. In the same or different embodiment, the statement processor 220 provides 212 a submitted statement 205 to a public forum monitor 211 who views the statement 205 in a client environment (an embodiment of which is discussed in conjunction with FIGS. 4B and 5F) and decides whether or not the statement 205 meets civility criteria 204. The statement processor 220 receives input 214 from the public forum monitor 211 including a decision regarding whether or not the submitted statement 205 meets civility criteria 204. The decision may include one of two binary options as follows:
(1) the statement meets civility criteria, or
(2) the statement does not meet civility criteria

Here, if the statement processor 220 receives the first option (i.e., the statement 205 meets civility criteria 204), the statement processor 220 assigns the submitted statement to the list of approved statements 225. Alternatively, if the statement processor 220 receives the second option (i.e., the statement 205 does not meet civility criteria 204) the submitted statement 205 remains on the list of pending statements 215.

As, will be readily apparent to, one of ordinary skill in the art, a public forum monitor's 211 decision as to whether or not a submitted statement 205 meets civility criteria 204 can be somewhat subjective. In some instances, for example, a first public forum monitor may reject a statement and a second public forum monitor may accept the statement which may lead to inconsistencies in public forum civility evaluations. Further, a public forum monitor 211 may inconsistently apply civility criteria 204 to one or more statements which may also lead to inconsistencies in public forum civility evaluations.

These problems may be mitigated using a number of techniques. For example, public forum monitors 211 may be trained so that they tend to apply civility criteria 204 more uniformly. Further, each submitted statement 205 may be reviewed by more than one public forum monitor 211, such as a first level public forum monitor who is primarily responsible for reviewing, one or more statements, and a second level public forum monitor who is responsible for validating/invalidating the first level review. These techniques enable a more robust and consistent statement review process. In this way, the public forum may achieve a more well-rounded balance of free speech rights and civility standards.

In some embodiments, if a public forum monitor 211 believes a statement 205 violates civility criteria 204, the public forum monitor 211 can perform one or more of the following:
(1) assign the submitted statement 205 to a list of pending statements 225 which are provided separately from all other public forum statements, or
(2) send a message to the statement submitter 201A (i.e. the public forum user who authored the statement), the message including an indication that the submitted statement 205 fails to meet civility criteria 204 of the public forum 202 (which can include a recitation of a particular civility criteria violated, e.g., the aforementioned personal attack rule), an explanation of why the submitted statement 205 violates the civility criteria 204 (which can include offending excerpts from the statement 205, e.g., “John Paul Jones is a liar.”), and/or an invitation to the statement author 201A to provide a modified statement 205′ and resubmit the modified statement 205′.

It should be noted that statements 205, 205′ are never edited or deleted by anyone other than the original author 201A. Further, a submitted submitter 201A may optionally choose to edit his/her own statement 205, without any prompting and/or regardless of whether or not the statement 205 meets civility criteria 204.

In a further embodiment, an author 201A of a statement 205 found to violate civility criteria 204 of the public forum 202 can appeal the decision to an appeal hander 221. To support such appeals, a further embodiment includes an appeal processor 230 to track a list of appealed statements 235. The appeal processor 230 may track civility evaluation information associated with an appealed statement 235, such as a particular civility criteria a public forum monitor 211 considers to be violated, an identifier that uniquely identifies a public forum monitor 211, a copy of the statement including highlighted offending portions thereof, statement submitter information which may include submitter attributes and an argument against the public forum monitor's 211 decision to reject the statement 235, and/or a decision from the appeal handler 221.

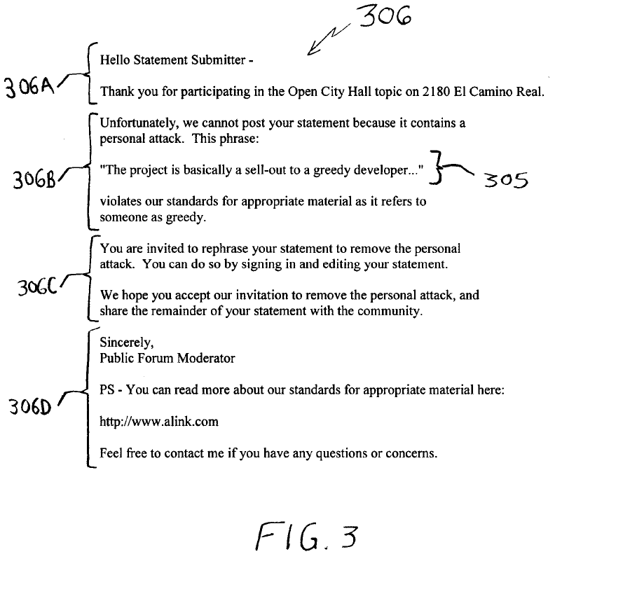

Referring now to FIG. 3, in a further embodiment, a message 306 (as may be similar to message 206 discussed in conjunction with FIG. 2) to modify a submitted statement that does not meet the civility criteria of the public forum includes information related to the submitted statement. The information may include a message 306B indicating that the submitted statement cannot be posted to the public forum and including a copy 305 of the submitted statement (“The project is basically a sell-out to a greedy developer.”) The message 306B may also include a summary of why that submitted statement does not meet civility criteria (which may be referred to “standards for appropriate material”). In particular, the message 306B can indicate that the submitted statement “contains a personal attack” because “it refers to someone as greedy.”

The response 306 may further include an invitation 306C to modify the submitted statement to remove the offending portion (i.e. the personal attack). In particular, the invitation 306C may invite the submitter to sign into the public forum and edit the submitted statement so that it may be shared with other public forum users.

One or more portions 306A of the response 306 may include greetings and salutations, links to more information (such as information regarding civility criteria), and contacts.

### Registration, Authentication, Fraud Preventation

Referring again to FIG. 1, in some embodiments, the statement processor 120 assigns the submitted statement 105 to the list of approved statements 125 based on a registration status of the submitter 101A. Submitter information is used to confirm the registration status and to authenticate the submitter 101A to reduce and/or eliminate certain undesirable behavior. Examples of undesirable behavior include attempts by submitters to submit multiple statements when a public forum is configured to accept only a single statement per submitter, attempts by a submitter to submit a statement using another's identity, attempts by a submitter who resides outside a public forum coverage area (e.g., a neighborhood, district, park, etc.) to submit a statement when the public forum is configured to accept only statements from submitters within the coverage area, etc.

In one example embodiment, the submitter information includes a unique submitter identifier. When the submitter 101A submits a statement 105, the submitter's unique identifier is saved or toggled in a public forum memory. The statement processor 120 checks the public forum memory for the saved submitter identifier (or for a particular toggle value) and if found, rejects the submitted statement 105 since the submitter 101A has already submitted a statement 105 to the public forum 102. This can help prevent a submitter 101A from attempting to submit more than one statement 105 so that it appears that the submitter's viewpoints/opinions are more prevalent and common among the public than they really are (thereby potentially influencing government agency action and deliberation).

In the same or different embodiment, each submitter 101A is required to properly register before submitting a statement 105. For example, the submitter 101A may have to submit an electronic mail address, a name, etc. and verify the submitted electronic mail address and name before being allowed to submit a statement 105. This can help prevent fraudulent submissions, for example, from a so-called “bot” that is configured to send repeated statements from fraudulent sources. In still other instances, submitter authentication helps prevent identity theft, which may occur if a submitter 101A provides a false identity.

Another goal of submitter authentication is to restrict public statements to members of the public who reside within a certain geographic region affected by a public forum agenda item and/or topic. Here, the submitter information may optionally include the submitter's residential address that can be verified against the subject geographic area (e.g., by determining whether or not the submitter resides within the geographic area). For example, an agenda item may include issues of concern related to a temporary housing facility to be located within a subject neighborhood. Here, it is desirable that the only members of the public who reside within the neighborhood (e.g., all homes with 200 feet of the temporary housing facility) influence the public discourse regarding the temporary housing facility. This may also help prevent meddling by other members of the public who don't have a direct stake in the outcome. For example, members of the public who reside outside the neighborhood may attempt to submit statements 105 in favor of locating the temporary housing facility in, the subject neighborhood in order to prevent such a facility from being located in his/her own neighborhood.

### Submitter Anonymity

In some embodiments, submitter information includes a submitter anonymity indicator that allows a statement submitter to remain anonymous. For example, the submitter's name is not shown when a public forum user views the submitter's statement. There are many reasons why a submitter may choose to remain anonymous. For example, a submitter may feel that his/her statement may interfere with a job, business or other personal relationship.

In a further embodiment, a public forum administrator can configure whether or not to allow a submitter to remain anonymous. For example, a government agency may desire full disclosure of all public forum users, in which case the submitter anonymity indicator is disabled. Alternatively, a government agency may allow a submitter to remain anonymous so that submitters can feel more comfortable expressing themselves without fear of embarrassment or even reprisal from others in the community. For example, a submitter may disagree with his/her neighbor on a particularly sensitive issue. The submitter can choose to remain anonymous so that the submitter does not potentially jeopardize his/her relationship with that neighbor.

It should be noted that a submitter's information is known to the statement processor to enable submitter authentication and statement verification.

Referring now to FIG. 4, in which like elements to FIG. 1 are shown with like reference numerals, a method 150 for conducting a public forum 102 of a government agency includes at 160 receiving a statement 105 submitted by a public forum user 101A, the statement 105 related to the public forum 102 of the government agency. At 170, the statement 105 is processed including assigning the statement 105 to a list of pending statements 115. The statement 105 is evaluated at 180 according to civility criteria 104 of the public forum 102 and if the statement 105 meets civility criteria 104 at 182 (designed by option 182A), then at 190 the statement 105 is assigned to a list of approved statements 125 on the basis of the civility evaluation 180.

The method 150 further includes, at 195 receiving a request 107 from a public forum user 101B for the statement 105 and at 196 a sending a response 106 to the public forum user 101B including information related the statement 105.

The method 150 may optionally include at 164 obtaining registration information from the public forum user 101A including at 164A verifying credentials of the public forum user 101A and at 164B, if the credentials are found to be valid, assigning the statement 105 to the list of pending statements (at 170) and performing the civility evaluation (at 180). In the alternative, at 164C if the credentials are found to be invalid, then at 164D, the method 150 includes sending a message at 166 to the public forum user 101A to request registration information. In some embodiments, sending the message 166 includes sending an electronic mail message to the public forum user 101A.

In some embodiments, the method 150 may optionally include at 182B, if the statement does not meet civility criteria 104, at 184 sending a message 168 to the public forum user 101A including information as to why the statement 105 did not meet civility criteria 104 and an invitation to the public forum user 101A to modify and resubmit the statement 105.

Referring now to FIGS. 4A, 4B, and 4C, embodiments of a public forum processor 400 according to the systems and methods described herein are shown interacting with public forum users (generally designated by reference numeral 401), public forum administrators 421, and public forum monitors 411. It should be noted that users (i.e. users 401, 411, 421) may interact with the public forum processor 400 in different ways using a different technologies, devices, and services. For example, some none, or all users 401, 411, 421 may use client devices (generally designated as reference numeral 423) including, but not limited to, desktop computers, laptop computers, personal digital assistants, smart phones, etc. to interact with the public forum processor 400 over a network (e.g., a local area network, an intranet, or the Internet). In such configurations, the public forum processor 400 may execute on a server computer and/or be provided as a service by an application service provider.

In still other configurations, users 401, 411, 421 may interact with public forum, processor 400 on the same computer.

Referring now to FIG. 4A, at 402, a public forum administrator 421 sends a command to the public forum processor 400 to define and configure a new public forum. In some embodiments, the public forum processor 400 provides a client graphical user interface (GUI) 403 in response to a command received from the public forum administrator 421 to create a new public forum. The public forum administrator 421 uses the GUI 403 to view, select, and edit administrative settings and behaviors of the public forum. The public forum administrator 421 views the GUI 403 on a client device 423.

It should be noted that configuring the public forum may be an iterative process. After creating the public forum, a public forum administrator 421 may view and edit public forum settings and behaviors any number of times as, desired, needed, or necessary. Further, a first public forum administrator may create the public forum (as well as define the settings and behaviors), while a second public forum administrator edits and fine-tunes the public forum settings and behaviors.

Referring now to FIG. 5A and again to FIG. 4A, an embodiment of an administrator GUI 503 provided by the public forum processor 400 enables the public forum administrator 421 to view settings of a public forum 502 (in this example, called “FISCAL YEAR 2011 BUDGET”). Here, the GUI 503 provides a topic name and number 503A, a phase option 503B (i.e. a phase including whether the public forum 502 is open, closed, etc.), whether or not to show a tally of statements 503C (i.e. a listing of prior submitted statements that may include categories of statements), whether or not the public forum is public 503D (i.e. some public forums may be tested in private among a set of test users before broadcast to the public), whether or not to allow statement submitters an option to submit statements anonymously 503E (as may be associated with the submitter anonymity indicator discussed above), a public forum question 503F (i.e. a description of the public forum topic), a public forum snippet 503G (i.e. information that may support the public forum 502), and other options such as a public forum deadline (i.e. the date/time the public forum 502 will no longer accept new statements), decision date (i.e. the date/time a government agency expects to make a decision that may be associated with the public forum 502), a final status, address name, and/or full address name.

When actuated, an edit button 503I sends a command to the public forum processor 400 to provide another administrative GUI that enables the public forum administrator 421 to edit public forum settings and behaviors (503A-503G) as well as provide other information associated with a public forum 502. Examples of such settings, behaviors, and information include, but are not limited to, the following:
formatting public forum topic and agenda item introductions for both text and hypertext markup language (HTML) rendering
opening and closing topics and agenda items
managing public forum deadlines associated with statement submissions
designing multiple choice responses to public forum questions
grouping public forum topics and agenda items together to optimize navigation
distributing public forum updates via electronic mail, real simple syndication (RSS), Twitter (a service provided by Twitter, Inc. of San Francisco, Calif.), Facebook (a service provided by Facebook, Inc. of Palo Alto, Calif.), blogs, short messaging services, and/or other services
distributing public forum topics and agenda items to key individuals and civic organizations in the community
writing summaries of statements and responses for public forum analysis and finalize statements

Referring again to FIG. 4A, at 406 a public forum user 401A sends a request to the public forum processor 400 to retrieve a list of one or more public forums of a government agency. The request may include an identifier that uniquely identifies the government agency to enable the public forum processor 400 to lookup the government agency (e.g., by querying a relational database management system) to find and return all of the public forums defined for the government agency. At 408, the public forum processor 400 finds all the public forums of the government agency and sends a list of the public forums to the public forum user 401A.

In some embodiments, the public forum processor 400 provides a client graphical user interface (GUI) 409 in response to a request received from the public forum user 401A to retrieve the list of one or more public forums of a government agency. The public forum user 401A uses the GUI 409 to view the list of public forums and to select one or more of the public forums for viewing.

Referring now to FIG. 5B and again to FIG. 4A, an embodiment of a GUI 509 provided by the public forum processor 400 enables a public forum user 401A to view a list of public forums 510 of a government agency 511 (here, the City of Palo Alto, Calif.). In this example, list 510 includes a first public forum listing 520A, a second public forum listing 520B, and a third public forum 520C listing (generally designated by reference numeral 520). It should be noted that on GUI 509 the public forum listings 520 are link-enabled. In other words, the public forum user 401A may retrieve a public forum by clicking on a public forum listing 520.

At 430, the public forum user 401A clicks a public forum listing 520 to view the corresponding public forum. For example, the public forum user 401A can click on the listing 520B to, view the public forum named “Council Meeting Feb. 8, 2010.”

In a further embodiment, GUI 509 is provided for viewing in a web browser 513 such as the Internet Explorer web browser manufactured by Microsoft Corporation of Redmond, Wash. and/or the Safari web browser manufactured by Apple Corporation of Cupertino, Calif. The web browser 513 executes on the client device 423.

In a further embodiment, a GUI 509′ (denoted by dashed line) is provided as an element embedded in application. In particular, the GUI 509′ may be embedded in an application using object linking and embedding and in a web browser using, for example, a Hypertext Markup Language (HTML) element such as an iFrame. The iFrame element allows the public forum processor 400 to provide access to a public forum by adding an iFrame tag to a website source file (to be loaded by the web browser). In FIG. 5B, for example, GUI 509′ is provided in the city of Palo Alto's webpage by including the following iFrame tag:

<iFrame style=“border-bottom: medium none; border-left: medium none;
border-top: medium none; border-right: medium none”
id=“public_forum_session1” height=“1200” marginheight=“0”src=
“http://www.peakdemocracy.com/portals/5/forum_home?a=77”
frameborder=“0”width=“600”name=“ public_forum_session
City of Palo Alto, CA” marginwidth=“0”></iFrame>

This feature enables public forums to be distributed and used by a potentially wider audience and without having to redirect users to another website. For example, public forum users 401 may access a public forum from a first website associated with the government agency, a second website associated with a news agency, a third web site of a member of the public, a fourth web site of a business concern with a stake or interest in the public forum, etc. It should be noted that GUI 509′ should not construed as limited to these above-described implementations, which are provided for illustrative purposes only. Other implementations such as eXtensible Markup Language (XML), ActiveX controls, etc. may be used.

Referring again to FIG. 4A, at 432 the public forum processor 400 receives a request for a public forum from the public forum user 401A and, in response, sends public forum statements (as well as other information) to the public forum user 401A. In some embodiments, the public forum processor 400 provides a client graphical user interface (GUI) 436 in response to a request from the public forum user 401A to retrieve a particular public forum. At 434, the public forum user 401A uses the GUI 436 to view public forum information, such as public forum statements.

Referring now to FIG. 5C and again to FIG. 4A, an embodiment of a GUI 536 provided by the public forum processor 400 enables a public forum user 401A to view a list of statement links 538 including a link to a list of pending statements 538A and a link to a list of approved statements 538B. GUI 536 may include other information, such as a deadline 538 for submitting statements and/or whether or not the deadline has passed.

At 450, the public forum user 401A sends a request for public forum statements. For example, the public forum user 401A can click on pending statement link 538A to retrieve one or more pending statements. In response, at 452 the public forum processor 400 retrieves the one or more pending statements and sends the pending statements to the public forum user 401A for viewing. In some embodiments, the public forum processor 400 can include information related to one or more of the pending statements and, in particular, information related to a statement submitter. For example, the public forum processor 400 can determine whether or not the statement submitter desires to remain anonymous by determining (at 454) whether or not the submitter's anonymity indicator has been activated. At 454A, if the anonymity indicator has been activated, the public forum processor 400 then determines (at 456) whether or not the government agency has disabled anonymity. If so, then at 456A the public forum processor 400 sends submitter identification information (for example, the submitter's name) along with the submitter's statement. In the alternative at 456B, the submitter's identification information is removed and replaced with an anonymity tag at 457 (for example, the tag “Semi-anonymous”). At 454B, if the anonymity indicator has not been activated, then the public forum processor 400 sends the submitter identification information along with the submitter's statement.

In some embodiments, the public forum processor 400 provides a client graphical user interface (GUI) 460 in response to a command received from the public forum user 401A to retrieve public forum statements. At 463, the public forum user 401A uses the GUI 460 to view the public forum statements.

Referring now to FIG. 5D and again to FIG. 4A, an embodiment of a GUI 560 provided by the public forum processor 400 enables a public forum user 401A to view one or more public forum statements 562. Here, a public forum statement 562 is shown along with other statement submitter information including a semi-anonymity tag 564 (“Semi-anonymous”) indicating that the submitter desires to remain anonymous to statement readers (i.e. public forum user 401A), a submitter city of residence tag 566 (“Lake Oswego”) to, identify the submitter's residential information, and a date/time of the statement 567. GUI 560 also includes the statement submitter's registration status 568. Here, the registration status 568 indicates that the statement submitter has not finished registering with the public forum processor 400. This helps alert statement readers 401A that the statement is potentially fraudulent, since the public forum processor 400 has not authenticated the statement submitter.

Referring now to FIG. 4B, at 470 a public, forum user 401B, who submits statements to a public forum (i.e. a statement submitter), composes and submits a statement to the public forum processor 400. In some embodiments, the public forum processor 400 provides a GUI 471 to the public forum user 401B that allows the public forum user 401B to compose and submit a public forum statement.

Referring now to FIG. 5E and again to FIG. 4B, an embodiment of a GUI 571 provided by the public forum processor 400 enables a public forum user 401B to compose and submit a statement to the public forum. GUI 571 includes public forum information such as the name of the public forum 579 (here, “Council Meeting of Feb. 8, 2010”), a name of the public forum agenda item 579A (here, “Stanford Ave/El Camino Streetscape: Overview”), and a question 577.

GUI 571 includes a statement input area 574 that can accept text input from the public forum user 401B and includes editing commands. A first toggle button 576 allows the statement submitter (i.e. public forum user 401B) to remain anonymous, and second toggle button 578 allows the statement submitter to decide whether or not to display his/her city of residence with the statement. GUI 571 may further include a preview button 573 that allows the statement submitter to preview the statement, and submit button 575 that allows the statement submitter to submit the statement. GUI 571 may optionally denote required fields 573 that the submitter must select and/or for which input is required (such as the statement and whether or not to remain anonymous). The required fields 573 may include information that is necessary in order to abide by free speech rights of the statement submitter while also balancing such rights with public forum civility and statement appropriateness.

At 472, the public forum processor 400 receives a statement mission from the public forum user 401B including a statement and associated information for processing. The public forum processor 400 assigns the submitted statement to a list of pending statements and at 473 determines whether or not the public forum user 401B is registered and if not, then at 473B the public forum processor 400 at 474 sends a registration request to the public forum user 401B, which may be in the form of an electronic mail to the public forum user 401B. At 475, the public forum user 401B sends registration information, which may be in response to the electronic mail, and at 476 the public forum processor 400 receives, and verifies the registration information. In the alternative at 473A, the public forum processor 400 proceeds to 477.

At 477, the public forum processor 400 evaluates the submitted statement according to civility criteria 478 as discussed in conjunction with FIG. 1. In some embodiments, at 477A the statement evaluation is at least partially performed by a public forum monitor 411 as discussed in conjunction with FIG. 2. In these embodiments, the public forum processor 400 may optionally provide a GUI 480 to the public forum monitor 411 that allows the public forum monitor 411 to view submitted statements and other public forum information to facilitate statement evaluation.

Referring now to FIG. 5F and again FIG. 4B, an embodiment of a GUI 580 provided by the public forum processor 400 enables the public forum monitor 411 to evaluate submitted statements. In this embodiment, the GUI 580 includes a table 581 that includes the statement submitter's name 581A and electronic mail address 581B, an issue 581C (i.e. a topic and/or agenda item about which the statement pertains) the statement text 581D, an indication of whether or not the submitter desires to show his/her name 581E, and/or whether or not the statement has been accepted 581F. An accept button 582 allows the public forum monitor 411 to accept the statement and a mark reviewed button 584 allows the public forum monitor 411 to indicate that the statement has been reviewed.

At 478, if the public forum monitor 411 decides to accept the statement (at 478A), then at 482 in response to the decision the public forum processor 400 assigns the statement to a list of approved statements. In a further embodiment, the public forum processor 400 changes the status of the statement from pending to approved and moves the statement from the list of pending statements to the list of approved statements. In another embodiment, at 483 the statement is subject to another review, such as a supervisory review. This may include a review by representatives of the government agency sponsoring the public forum who may desire to take part in the statement evaluation process.

In the alternative at 478B, if the public forum monitor 411 decides not to accept the statement, then at 481 in response to the decision the public forum processor 400 may optionally send an message to the public forum user 401B including information as to why the statement was not accepted and/or an invitation to the public forum user 401B to modify and resubmit the statement, as may be similar to message 306 discussed in conjunction with FIG. 3. At 487, the public forum user 401 views the invitation and in response, at 484 the public forum user 401B modifies and resubmits the statement. At 477, the public forum processor reevaluates the modified statement.

Referring now to FIG. 4C, in some embodiments the public forum processor 400 renders one or more relationships regarding information associated with a public forum. The relationships include certain statistics related to the public forum including, but not limited to, public forum user participation rates and efficacy factors, which may be provided to a public forum users 421 as printed reports. In these embodiments, public forum information may optionally be saved in relational database management system (RDMS) 490 including one or more database tables (generally designated by reference numeral 491) for organizing public forum data. These tables 491 can include a public forum definitions table 491A organized by government agency and including attached civility criteria, submitted statements etc., public forum users table 491B including statement submitters and readers, user attributes table 491C including user name, residence, preferences, etc., civility criteria table 491D including predetermined civility criteria, rules, etc., and statements table 491E including pending and/or approved statements.

At 492, a public forum user 421, such, as a government official, may compose queries and send the queries to the public forum processor 400 for processing. At 493, the public forum processor 400 runs the query against the RDMS 490. At 494, the public forum processor 400 receives and organizes query results and may optionally format the query results as prepackaged reports and send the reports 495 to public forum users 421 for viewing.

Referring now to FIG. 5G and again to FIG. 4C, an exemplary report 595A relates to daily visitors to a public forum and includes a bar graph 596 having, a first axis 596A corresponding to an arbitrary series of dates and a second axis 596B corresponding to an arbitrary numerical range indicative of a number of public forum users visiting the public forum. Here, visiting public forum users includes users who have only read statements and users who have read and submitted statements. The bar graph compares total visitors 596C (i.e. users who have read and submitted statements), participating users 596D (i.e. users who have submitted statements), and subscribed users 596E (i.e. users who have submitted statements and subscribed to the public forum). Advantageously, report 595A can provide valuable information to government agencies such as a comparison of those who only read statements (who can be said to be passive participants) to those who read and submit statements (who can be said to be active participants). In particular, it can be said that the more active participants there are in a public forum, the more expression (and variety) of public sentiment. Further, government officials may obtain a more balanced spectrum of opinions from the public, especially for citizens who may be afraid to speak out during public hearings and/or who are unable to attend evening meetings. Further, in embodiments in which each submitter is limited to a single statement, the active participation rate may be more reflective of the makeup of public sentiment.

Another exemplary report shown in FIG. 5H relates to cumulative visitors to a public forum.

In a further embodiment, the public forum processor 400 determines a public forum efficacy factor based on a number of received submitter statements and a predetermined statement completion time for each statement. The predetermined statement completion time may optionally be based on an average of actual time public hearing speakers required to make statements at public hearings. The efficacy factor E_{F} can be represented by the following relationship:

Number of received submitter statements*Predetermined statement completion time

For example, if a public forum included 80 statements, and the predetermined statement completion time equals 3 minutes/statement, then E_{F} equals 4 hours. In other words, these 80 statements would require a 4 hour public hearing to be voiced which is a long time for public hearing, participants to remain in one place, especially if held during the evening hours. Advantageously, the E_{F} can help government officials understand just how convenient a public forum may be for public forum users and/or how efficiently statements are received, processed, and posted. For example, a portion (or even all) of the 80 statements can be composed and submitted simultaneously to the public forum processor 400 for processing. These statements can also be submitted over the period during which the public forum is held open for public comment and these public statements can be entered at the public forum users' convenience.

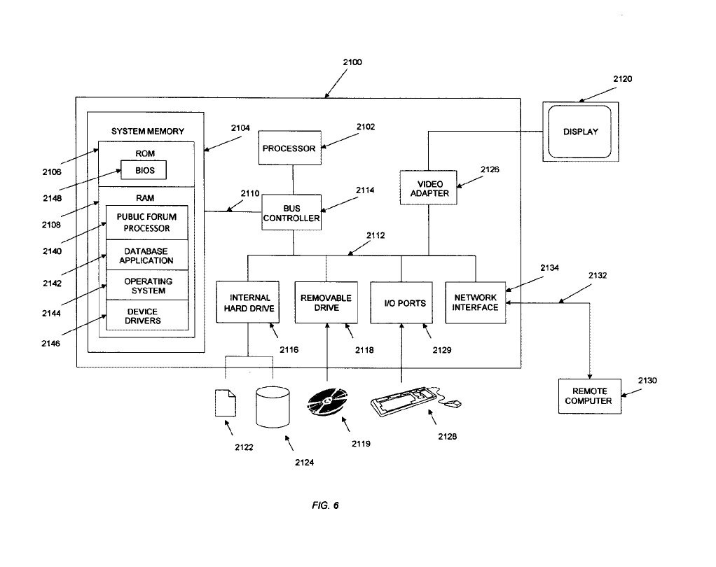

FIG. 6 illustrates a computer 2100 suitable for supporting the operation of an embodiment of the inventive systems and methods described herein. The computer 2100 includes a processor 2102, for example, a desktop processor, laptop processor, server and workstation processor, and/or embedded and communications processor. As by way of a non-limiting example, processor 2102 may include an Intel® Core™ i7, i5, or i3 processor manufactured by the Intel Corporation of Santa Clara, Calif. However, it should be understood that the computer 2100 may use other microprocessors. Computer 2100 can represent any server, personal computer, laptop, or even a battery-powered mobile device such as a hand-held personal computer, personal digital assistant, or smart phone.

Computer 2100 includes a system memory 2104 which is connected to the processor 2102 by a system data/address bus 2110. System memory 2104 includes a read-only memory (ROM) 2106 and random access memory (RAM) 2108. The ROM 2106 represents any device that is primarily read-only including electrically erasable programmable read-only memory (EEPROM), flash memory, etc. RAM 2108 represents any random access memory such as Synchronous Dynamic Random Access Memory (SDRAM). The Basic Input/Output System to (BIOS) 2148 for the computer 2100 is stored in ROM 2106 and loaded into RAM 2108 upon booting.

Within the computer 2100, input/output (I/O) bus 2112 is connected to the data/address bus 2110 via a bus controller 2114. In one embodiment, the I/O bus 2112 is implemented as a Peripheral Component Interconnect (PCI) bus. The bus controller 2114 examines all signals from the processor 2102 to route signals, to the appropriate bus. Signals between processor 2102 and the system memory 2104 are passed through the bus controller 2114. However, signals from the processor 2102 intended for devices other than system memory 2104 are routed to the I/O bus 2112.

Various devices are connected to the I/O bus 2112 including internal hard drive 2116 and removable storage drive 2118 such as a CD-ROM drive used to read a compact disk 2119 or a floppy drive used to read a floppy disk. The internal hard drive 2116 is used to store data, such as in files 2122 and database 2124. Database 2124 includes a structured collection of data, such as a relational database. A display 2120, such as a cathode ray tube (CRT), liquid-crystal display (LCD), etc. is connected to the I/O bus 2112 via a video adapter 2126.

A user enters commands and information into the computer 2100 by using input devices 2128, such as a keyboard and a mouse, which are connected to I/O bus 2112 via I/O ports 2129. Other types of pointing devices that may be used include track balls, joy sticks, and tracking devices suitable for positioning a cursor on a display screen of the display 2120.

Computer 2100 may include a network interface 2134 to connect to a remote computer 2130, an intranet, or the Internet via network 2132. The network 2132 may be a local area network or any other suitable communications network.

Computer-readable modules and applications 2140 and other data are typically stored on memory storage devices, which may include the internal hard drive 2116 or the compact disk 2119, and are copied to the RAM 2108 from the memory storage devices. In one embodiment, computer-readable modules and applications 2140 are stored in ROM 2106 and copied to RAM 2108 for execution, or are directly executed from ROM 2106. In still another embodiment, the computer-readable modules and applications 2140 are stored on external storage devices, for example, a hard drive of an external server computer, and delivered electronically from the external storage devices via network 2132.

The computer-readable modules 2140 may include compiled instructions for implementing the public forum processor described herein. The public forum processor, which may include a public forum statement broker and a statement processor for receiving and processing statements, may render the statements for output to display 2120 to enable users to view the statements. Further, public forum statements may be output to other systems for analysis and to share among organizations.

In a further embodiment, the computer 2100 may execute the statement broker on a first processor and the statement processor on a second processor. For example, the first and second processor may be respective processors of a dual-core processor. Alternatively, the first and second processor may respective first and second computing devices.

The computer 2100 may execute a database application 2142, such as Oracle™ database from Oracle Corporation, to model, organize, and query data stored in database 2124. The data may be used by the computer-readable modules and applications 2140 and/or passed over the network 2132 to the remote computer 2130 and other systems.

In general, the operating system 2144 executes computer-readable modules and applications 2140 and carries out instructions issued by the user. For example, when the user wants to execute a computer-readable module 2140, the operating system 2144 interprets the instruction and causes the processor 2102 to load the computer-readable module 2140 into RAM 2108 from memory storage devices. Once the computer-readable module 2140 is loaded into RAM 2108, the processor 2102 can use the computer-readable module 2140 to carry out various instructions. The processor 2102 may also load portions of computer-readable modules and applications 2140 into RAM 2108 as needed. The operating system 2144 uses device drivers 2146 to interface with various devices, including memory storage devices, such as hard drive 2116 and removable storage drive 2118, network interface 2134, I/O ports 2129, video adapter 2126, and printers.

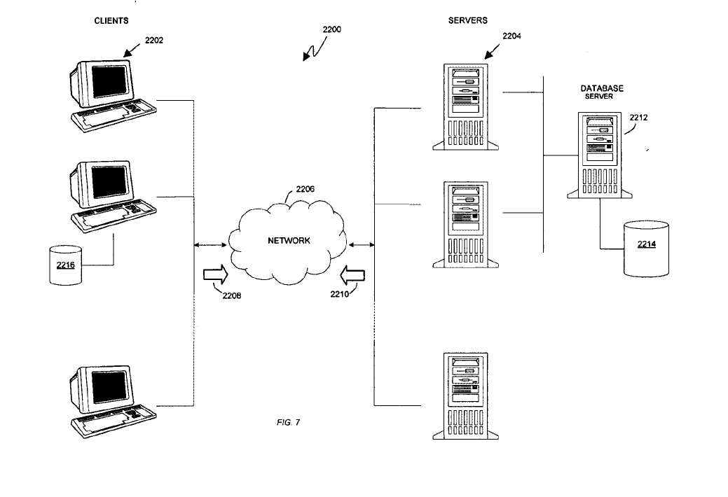

FIG. 7 illustrates a client-server environment 2200 for supporting the operation of an embodiment of the inventive systems and methods described herein. Client computers 2202 are coupled to server computers 2204 via a network 2206, such as an intranet or the Internet. Client computer users may access applications and resources executing on the server computers 2204 by issuing requests 2208 over network 2206. The requests 2208 may include command-line options and data values to delineate the requests. Server computers 2204 accept and process requests 2208 and may access structured data stored in databases 2214 on database servers 2212. Server computers 2204 return information 2210 to the client computers 2202 via network 2206. In response, client computers 2202 provide information in an appropriate format to client users, for example, using a web client or other client computer-readable modules. In one embodiment, the client computer 2202 may execute a local application for supporting the operation the systems and methods described herein, which may include accessing a local copy of data in a local database 2216.

It should be appreciated that rectangular elements in flow diagrams (typified by element 160 in FIG. 4), herein denoted “processing blocks,” represent computer software instructions or groups of instructions. Diamond shaped elements in flowcharts (typified by element 454 in FIG. 4A), herein denoted “decision blocks,” represent computer software instructions, or groups of instructions, which affect the execution of the computer software instructions represented by the processing blocks.

Alternatively, the processing and decision blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required of the particular apparatus. It should be noted that many routine program elements, such as initialization of loops and variables and the use of temporary variables are not shown. It will be appreciated by those of ordinary skill in the art that unless otherwise indicated herein, the particular sequence of blocks described is illustrative only and can be varied without departing from the spirit of the invention. Thus, unless otherwise stated the blocks described hereinabove are unordered meaning that, when possible, the steps can be performed in any convenient or desirable order.

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

What is claimed is:

1. A method for conducting a public forum of a government agency comprising:
in a public forum processor, receiving a statement from a submitter, the statement related to the public forum of the government agency;
processing the submitted statement including:
assigning the submitted statement to a list of pending statements;
evaluating the submitted statement according to civility criteria of the public forum of the government agency; and
on the basis of said civility evaluation, assigning the submitted statement to a list of approved statements; and
sending at least one pending statement in response to a request for the list of pending statements, including the content of the at least one pending statement and information related to said civility evaluation of the at least one pending statement.

2. The method of claim 1, wherein the public forum corresponds to an agenda item associated with a public hearing of the government agency.

3. The method of claim 1, wherein the public forum corresponds to a topic of interest related to the government agency.

4. The method of claim 1, wherein the civility criteria include identifying at least one undesirable word or phrase.

5. The method of claim 1, wherein civility criteria include order and decorum criteria of the public forum of the government agency.

6. The method of claim 5, wherein said order and decorum criteria of the public forum of the government agency include disruptiveness criteria of the public forum of the government agency.

7. The method of claim 1, wherein said civility evaluation of the submitted statement comprises:
sending a response to the statement submitter, the response including information related to the civility evaluation of the submitted statement and an invitation to modify the submitted statement.

8. The method of claim 1, wherein said assigning the submitted statement to a list of approved statements further comprises:
assigning the submitted statement to the list of approved statements based on a registration status of the submitter.

9. The method of claim 8, wherein said assigning the submitted statement to the list of approved statements based on the registration status of the submitter includes authenticating a submitter identifier associated with the submitter of the statement.

10. The method of claim 1, wherein said sending at least one pending statement in response to a request for the list of pending statements includes sending the at least one pending statement to a reader, at least one of the reader and the submitter being a citizen of a seat of government associated with the government agency.

11. The method of claim 1, further comprising:
sending at least one approved statement in response to a request for the list of approved statements, including the content of the at least one approved statement.

12. The method of claim 11, wherein said sending at least one approved statement in response to a request for the list of approved statements further includes sending the at least one approved statement to a reader, at least one of the reader or the submitter being a citizen of a seat of government associated with the government agency.

13. The method of claim 1, further comprising:
receiving information from the submitter including a submitter identifier,
wherein said sending at least one pending statement in response to a request for the list of pending statements further includes sending information related to the submitter identifier.

14. The method of claim 13, wherein the received submitter information further includes an anonymity indicator indicative of the submitter's desire to remain anonymous.

15. The method of claim 1, further comprising:
monitoring users of the public forum of the government agency, the users of the public forum including users submitting statements to the public forum and users requesting statements from the public forum; and
comparing the users submitting statements to the users requesting statements.

16. The method of claim 15, wherein said comparing includes evaluating a relationship of a number of users submitting statements to the public forum to a number of users requesting statements from the public forum, the relationship indicative of a user participation in the public forum of the government agency.

17. The method of claim 1, further comprising:
determining a public forum efficacy factor based on received submitter statements and a predetermined statement completion time.
wherein the public forum efficacy factor is determined according to:
a number of received submitter statements*the predetermined statement completion time,
wherein the predetermined statement completion time corresponds to a predetermined time required to complete a statement of the public forum of the government agency.

18. The method of claim 1, further comprising:
conducting the public forum of the government agency in a first session by embedding access to the public forum in a first web page; and
conducting the public forum of the government agency in a second session by embedding access to the public forum in a second web page.

19. A system for conducting a public forum of a government agency comprising:
a statement broker configured to receive a statement from a submitter, the statement related to the public forum of the government agency, and to assign the submitted statement to a list of pending statements;
a public forum processor configured to assign the submitted statement to a list of approved statements based on a civility evaluation of the statement according to predetermined civility criteria of the public forum of the government agency,
wherein the statement broker is further configured to send at least one pending statement in response to a request for the list of pending statements, including content of the at least one pending statement and information related to the civility evaluation of the at least one pending statement.

20. A computer-readable medium having encoded thereon software for conducting a public forum of a government agency, said software comprising instructions for:
evaluating a statement received from a submitter and related to the public forum of the government agency, including;
assigning the submitted statement to a list of pending statements; and
moving the submitted statement to a list of approved statements based on an evaluation of the submitted statement according to civility criteria of the public forum of the government agency; and
providing at least one pending statement in response to a request for the list of pending statements, including the content of the at least one pending statement and information related to the civility evaluation of the at least one pending statement.
